(19) United States
(12) Patent Application Publication
(10) Pub. No.: US 2010/0299382 A1
(43) Pub. Date: Nov. 25, 2010

(54) ARITHMETIC CIRCUIT AND POWER SAVING METHOD

(75) Inventor: Kazuhiro ABE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/783,085

(22) Filed: May 19, 2010

(30) Foreign Application Priority Data
May 21, 2009 (JP) 2009-123499

(51) Int. Cl. G06F 17/14

(52) U.S. Cl. 708/400

(57) ABSTRACT

An arithmetic circuit includes a rearranging unit that rearranges input signals sequentially inputted to the rearranging unit, so that current input signals do not change from immediately previous input signals, and an arithmetic processing unit that performs an arithmetic process on the rearranged input signals rearranged by the rearranging unit.

### CROSS-REFERENCE TO RELATED APPLICATIONS

This application is based upon and claims priority to prior Japanese Patent Application No. 2009-123499 filed on May 21, 2009 in the Japan Patent Office, the entire contents of which are incorporated herein by reference.

### FIELD

Various embodiments described herein relate to an arithmetic circuit and a power saving method.

### BACKGROUND

It has been hitherto known that CMOS (complementary metal oxide semiconductor) circuits in which current flows from the power supply to the ground because a switching operation of p-type transistors and n-type transistors is performed when input signals change. Regarding power consumption of such a CMOS circuit, there exits standby power, which is power consumed by steady-state current that flows when the CMOS circuit does not operate, and operating power, which is power consumed by current that flows because the above-described switching operation is performed in the CMOS circuit.

Here, the operating power increases with the operation rate of the CMOS circuit (i.e., the number of performance of the switching operation of the transistors), and the power consumption also increases. For example, when “0” and “1” are alternately input as input signals to the CMOS circuit, the switching operation is performed, and the operating power is consumed every time the input signals change.

[Patent Document 1] Japanese Laid-open Patent Publication No. 63-65711

[Patent Document 2] Japanese Laid-open Patent Publication No. 8-250999

### SUMMARY

According to an aspect of the invention, an arithmetic circuit includes a rearranging unit that rearranges input signals sequentially inputted to the rearranging unit, so that current input signals do not change from immediately previous input signals, and an arithmetic processing unit that performs an arithmetic process on the rearranged input signals rearranged by the rearranging unit.

### BRIEF DESCRIPTION OF THE DRAWINGS

FIG. 1 is a diagram for explaining an overview of an arithmetic circuit according to a first embodiment;

FIG. 2 is a block diagram of a configuration of the arithmetic circuit according to the first embodiment;

FIG. 3 is a table for explaining the relationships between inputs and outputs of a rearranging circuit according to the first embodiment;

FIG. 4 is a diagram for explaining a configuration of the rearranging circuit according to the first embodiment;

FIG. 5 is a table for explaining signal change probabilities for changes in an input signal in the first embodiment;

FIG. 6 is a table for comparing signal change probabilities in the arithmetic circuit according to the first embodiment with signal change probabilities in an arithmetic circuit of the related art;

FIG. 7 is a flowchart of an operation of performing processes with the arithmetic circuit according to the first embodiment;

FIG. 8 is a block diagram of a configuration of an arithmetic circuit according to a second embodiment;

FIG. 9 is a table for explaining the relationships between inputs and outputs of a rearranging circuit according to the second embodiment;

FIG. 10 is a diagram for explaining a configuration of the rearranging circuit according to the second embodiment;

FIG. 11 is a table for comparing signal change probabilities in the arithmetic circuit according to the second embodiment with signal change probabilities in an arithmetic circuit of the related art;

FIG. 12 is a table for explaining the relationships between inputs and outputs of a rearranging circuit according to a third embodiment;

FIG. 13 is a diagram for explaining a configuration of the rearranging circuit according to the third embodiment;

FIG. 14 is a table for comparing signal change probabilities in the arithmetic circuit according to the third embodiment with signal change probabilities in an arithmetic circuit of the related art;

FIG. 15 is a block diagram of a configuration of an arithmetic circuit according to a fourth embodiment;

FIG. 16 is a table for explaining the relationships between inputs and outputs of a rearranging circuit according to the fourth embodiment;

FIG. 17 is a diagram for explaining a configuration of the rearranging circuit according to the fourth embodiment;

FIG. 18 is a table for comparing signal change probabilities in the arithmetic circuit according to the fourth embodiment with signal change probabilities in an arithmetic circuit of the related art;

FIG. 19 is a table for explaining the relationships between inputs and outputs of a rearranging circuit according to a fifth embodiment;

FIG. 20 is a diagram for explaining a configuration of the rearranging circuit according to the fifth embodiment.

FIG. 21 is a table for comparing signal change probabilities in the arithmetic circuit according to the fifth embodiment with signal change probabilities in an arithmetic circuit of the related art;

FIG. 22 is a table for comparing the arithmetic circuit according to the fifth embodiment and the arithmetic circuit of the related art in terms of circuit scale and power consumption;

FIG. 23 is a block diagram of a configuration of an arithmetic circuit according to a sixth embodiment; and

FIG. 24 is a block diagram of a configuration of an arithmetic circuit according to a seventh embodiment.

### DESCRIPTION OF EMBODIMENTS

Hereinafter, arithmetic circuits according to embodiments and power saving methods in the embodiments will be described in detail with reference to the accompanying drawings.

In one of the embodiments given below, an overview of an arithmetic circuit according to a first embodiment, a configuration of the arithmetic circuit, and a flow of a process performed by the arithmetic circuit will be sequentially explained. Note that, hereinafter, an example will be described, in which an adder circuit is applied as a circuit that is targeted for saving power.

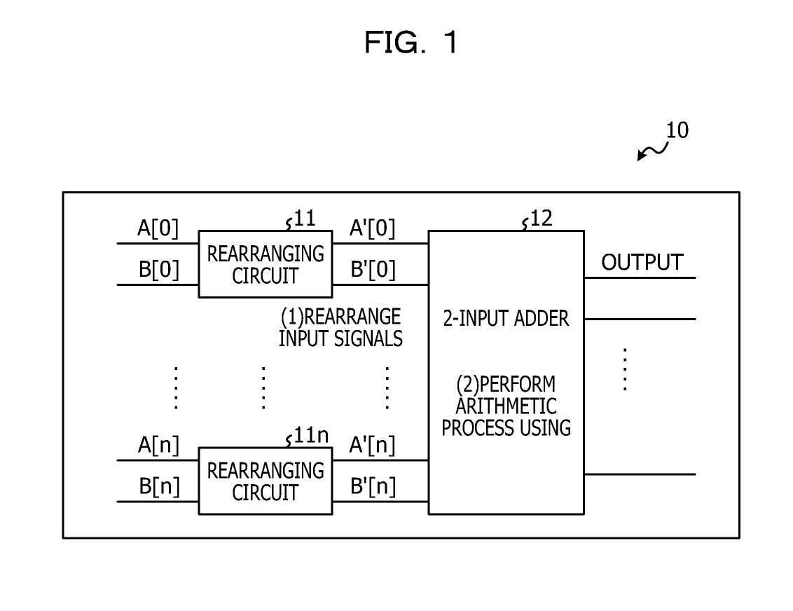

First, the overview of the arithmetic circuit according to the first embodiment will be described with reference to FIG. 1. FIG. 1 is a diagram for explaining the overview of the arithmetic circuit according to the first embodiment.

As illustrated in FIG. 1, an arithmetic circuit 10 includes a plurality of rearranging circuits 11 to 11n that are provided at a previous stage to a 2-input adder 12 and that rearrange (or exchange) input signals. Each of outputs of the rearranging circuits 11 to 11n is connected to the 2-input adder 12 using two signal lines. In the arithmetic circuit 10, two input signals (inputs A and B in an example illustrated in FIG. 1) are input from each of the rearranging circuits 11 to 11n to the 2-input adder 12 via the signal lines.

The rearranging circuit 11 of the arithmetic circuit 10 according to the first embodiment rearranges (or exchanges) the input signals, which are sequentially input, so that the current input signals do not change from the immediately previous input signals (see (1) illustrated in FIG. 1). More specifically, when the input A is “1” and the input B is “0”, the rearranging circuit 11 of the arithmetic circuit 10 rearranges (or exchanges) the inputs A and B to obtain an output A′ of “0” and an output B′ of “1” so that the values of the inputs A and B which have been input from individual paths are biased.

In other words, when both of a probability that each of the input signals which are input to the rearranging circuit 11 is “0” and a probability that the input signal is “1” are ½ (hereinafter, referred to as “probabilities of occurrence”), the probabilities of occurrence of all four combinations of input signals (the input A of “0” and the input B of “0”, the input A of “0” and the input B of “1”, the input A of “1” and the input B of “0”, and the input A of “1” and the input B of “1”) are all the same (¼).

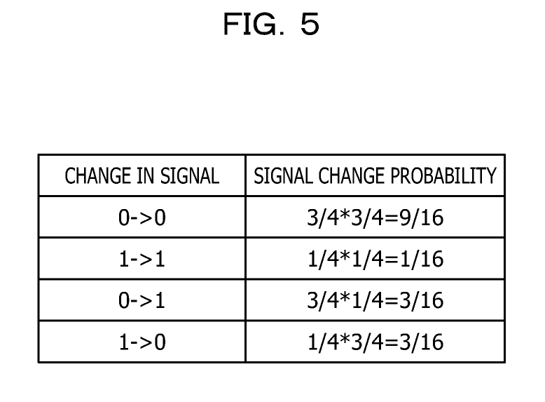

In such a case, as a result of performance of a process of rearranging the input signals, a probability of occurrence of the output A′ of “0” and a probability of occurrence of the output A′ of “1” are ¾ and ¼, respectively. Accordingly, a signal change probability, which is a probability that an input signal in the next cycle changes from an input signal in the current cycle, is reducible (see FIG. 5 given below). Here, the probability that an input signal in the next cycle changes from an input signal in the current cycle is a sum of a probability that the output A′ changes from “0” to “1” and a probability that the output A′ changes from “1” to “0”.

Then, the 2-input adder 12 sequentially accepts the input signals that have been rearranged (or exchanged) by the rearranging circuit 11, and performs an arithmetic process (see (2) illustrated in FIG. 1). Here, the 2-input adder 12 is a circuit through which current flows only when the input signals change, and which obtains a result that does not change even when the two input signals are rearranged (or exchanged) as equivalent signals having the same weight.

As described above, in the arithmetic circuit 10, the input signals, which are signals that are sequentially input, are rearranged (or exchanged) so that the current input signals do not change from the immediately previous input signals. Thus, the signal change probabilities for changes in the input signals are reducible. As a result, the power consumption of the adder is reducible.

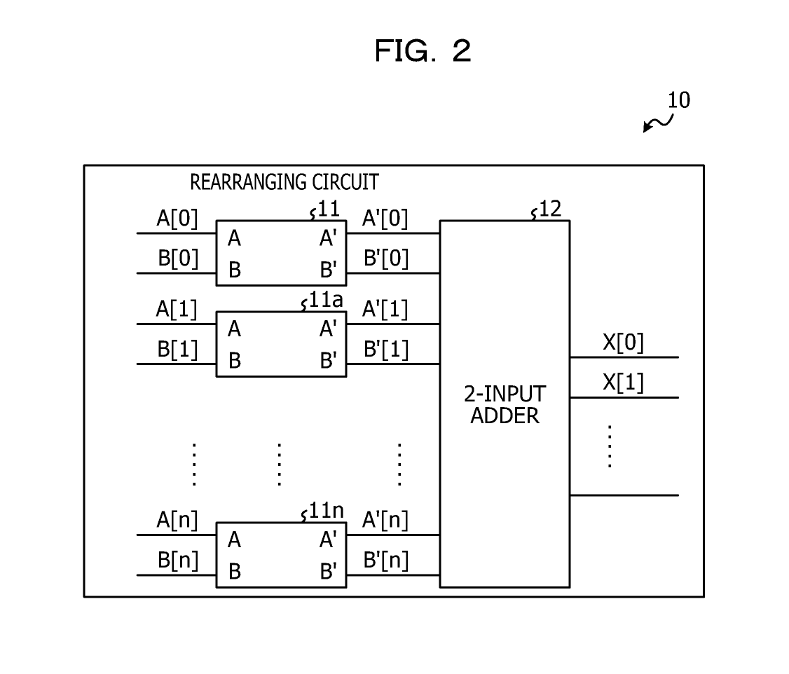

Next, a configuration of the arithmetic circuit 10 illustrated in FIG. 1 will be described with reference to FIG. 2. FIG. 2 is a block diagram of the configuration of the arithmetic circuit according to the first embodiment. As illustrated in FIG. 2, the arithmetic circuit 10 includes the rearranging circuit 11 and the 2-input adder 12. The rearranging circuit 11 and the 2-input adder 12 are connected to each other via signal lines or the like. Hereinafter, a process performed by each of the units will be described.

The rearranging circuit 11 rearranges (or exchanges) the input signals, which are signals that are sequentially input to the 2-input adder 12, so that the current input signals do not change from the immediately previous input signals. More specifically, the rearranging circuit 11 receives two input signals. When the rearranging circuit 11 determines that it is necessary to perform a rearrangement process for the combination of the two input signals to the 2-input adder 12, the rearranging circuit 11 performs the rearrangement process on the input signals. For example, when the input A is “1” and the input B is “0”, the rearranging circuit 11 rearranges (or exchanges) the inputs A and B to obtain the output A′ of “0” and the output B′ of “1”.

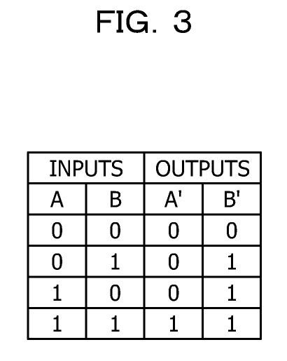

Here, the relationships between inputs and outputs of the rearranging circuit 11 will be described with reference to FIG. 3. FIG. 3 is a table for explaining the relationships between inputs and outputs of the rearranging circuit according to the first embodiment. As illustrated in FIG. 3, when the input A is “0” and the input B is “0”, when the input A is “0” and the input B is “1”, and when the input A is “1” and the input B is “1”, without rearranging the inputs A and B that are input signals, the rearranging circuit 11 just outputs the input signals. Furthermore, when the input A is “1” and the input B is “0”, the rearranging circuit 11 rearranges (or exchanges) the inputs A and B to obtain the output A′ of “0” and the output B′ of “1”.

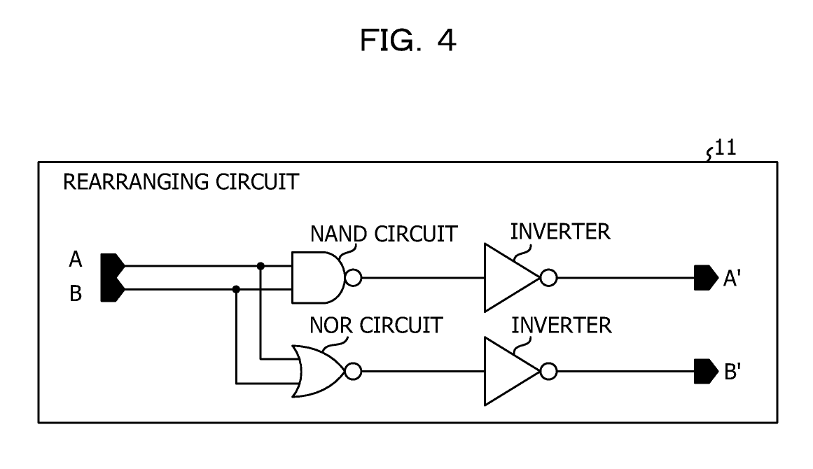

Here, a circuit configuration of the rearranging circuit 11 will be described with reference to FIG. 4. FIG. 4 is a diagram for explaining the configuration of the rearranging circuit according to the first embodiment. As illustrated in FIG. 4, the rearranging circuit 11 includes a NAND (Negative AND) circuit, a NOR (Negative OR) circuit, and two inverters. For example, when the input A is “1” and the input B is “0”, the NAND circuit outputs “1”, and, then, one of the two inverters outputs “0” as the output A′. Furthermore, when the input A is “1” and the input B is “0”, the NOR circuit outputs “0”, and, then, the other inverter outputs “1” as the output B′.

Here, signal change probabilities for changes in an input signal will be described with reference to FIG. 5. FIG. 5 is a table for explaining signal change probabilities for changes in an input signal. As described above, when the input A is “1” and the input B is “0”, the rearranging circuit 11 performs the process of rearranging the inputs A and B to obtain the output A′ of “0” and the output B′ of “1”.

In other words, regarding an input signal that is input to the rearranging circuit 11, when both of a probability of occurrence of the input signal of “0” and a probability of occurrence of the input signal of “1” are ½, the probabilities of all four combinations of input signals (the input A of “0” and the input B of “0”, the input A of “0” and the input B of “1”, the input A of “1” and the input B of “0”, and the input A of “1” and the input B of “1”) are all the same (¼).

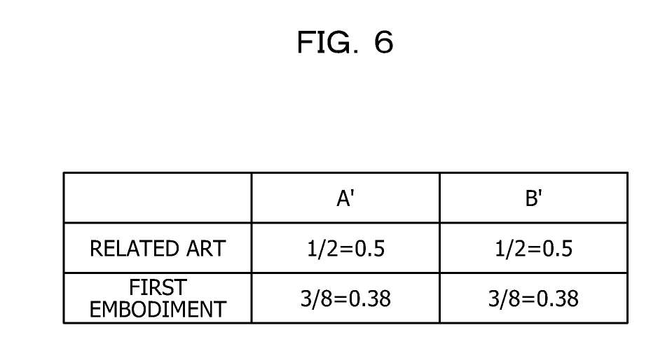

In this case, the rearranging circuit 11 performs the process of rearranging (or exchanging) the input signals, whereby a probability of occurrence of the output A′ of “0” and a probability of occurrence of the output A′ of “1” are ¾ and ¼, respectively. Accordingly, as illustrated in FIG. 5, a probability that the output A′ changes from “0” to “1” is 3/16, and a probability that the output A′ changes from “1” to “0” is also 3/16. As a result, as illustrated in FIG. 6, the rearranging circuit 11 performs the process of rearranging the input signals, whereby signal change probabilities are “ 3/8”. Thus, the signal change probabilities are reducible, compared with signal change probabilities of “½” in an arithmetic circuit of the related art in which no process of rearranging input signals is performed.

The 2-input adder 12 sequentially accepts the input signals that have been rearranged (or exchanged) by the rearranging circuit 11, and performs an adding process. Here, the 2-input adder 12 is a circuit through which current flows only when the input signals change, and which obtains a result that does not change even when the two input signals are rearranged as equivalent signals having the same weight.

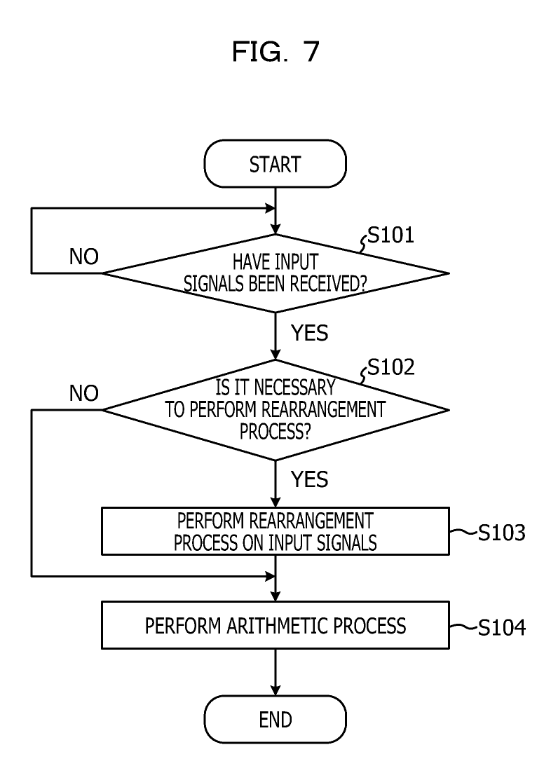

Next, processes performed by the arithmetic circuit 10 according to the first embodiment will be described with reference to FIG. 7. FIG. 7 is a flowchart of an operation of performing processes with the arithmetic circuit according to the first embodiment.

As illustrated in FIG. 7, when the rearranging circuit 11 of the arithmetic circuit 10 receives input signals (YES in step S101), the rearranging circuit 11 determines whether or not it is necessary to perform the rearrangement process for the combination of the input signals (in step S102). Then, when the rearranging circuit 11 determines that it is not necessary to perform the rearrangement process for the combination of the input signals (NO in step S102), the rearranging circuit 11 does not perform the rearrangement process on the input signals.

Furthermore, when the rearranging circuit 11 determines that it is necessary to perform the rearrangement process for the combination of the input signals (YES in step S102), the rearranging circuit 11 performs the rearrangement process on the input signals (in step S103). Then, the 2-input adder 12 sequentially accepts the input signals, and performs an arithmetic process (in step S104).

As described above, in the arithmetic circuit 10, the input signals, which are signals that are sequentially input to the arithmetic circuit 10, are rearranged (or exchanged) so that the current input signals do not change from the immediately previous input signals. Then, in the arithmetic circuit 10, the rearranged input signals are sequentially accepted, and an arithmetic process is performed. Thus, in the arithmetic circuit 10, the signal change probabilities are reducible. As a result, the power consumption of the adder is reducible when the adder circuit operates.

Furthermore, in the arithmetic circuit 10, when input signals are input from two paths to the arithmetic circuit 10, the individual input signals are rearranged (or exchanged) so that the values of the input signals which are input from the individual paths are biased. Thus, the signal change probabilities are reducible. As a result, the power consumption of the adder is reducible when the adder circuit operates.

In the above-described first embodiment, a case in which a rearranging circuit is used at a previous stage to a 2-input adder is described. However, a rearranging circuit may be used at a previous stage to a 3-input adder.

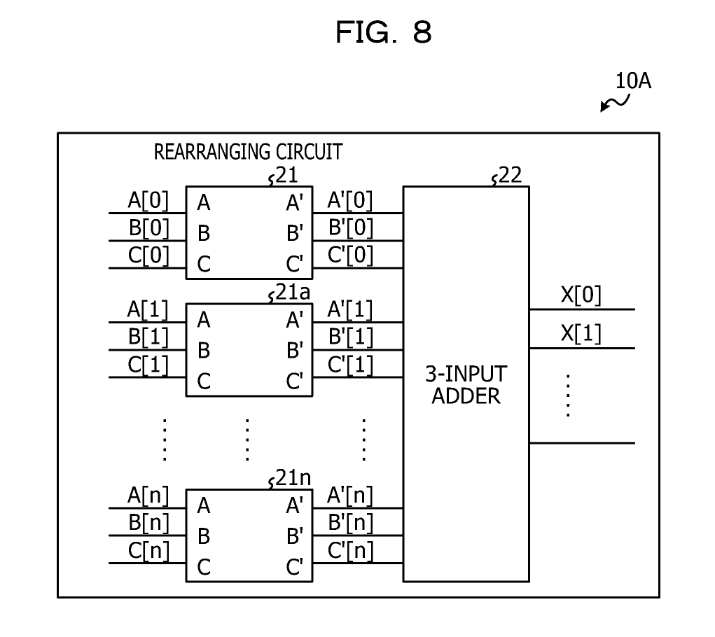

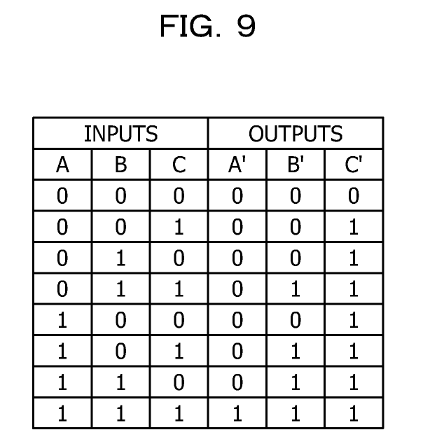

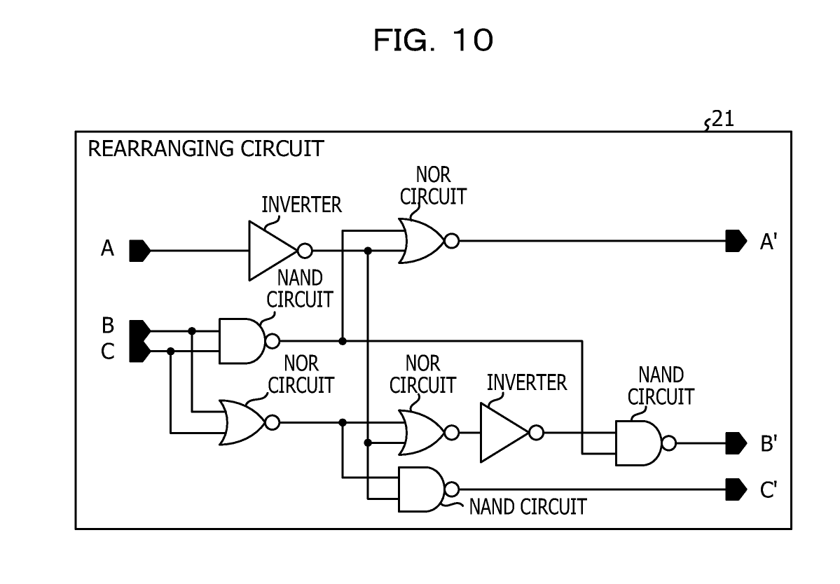

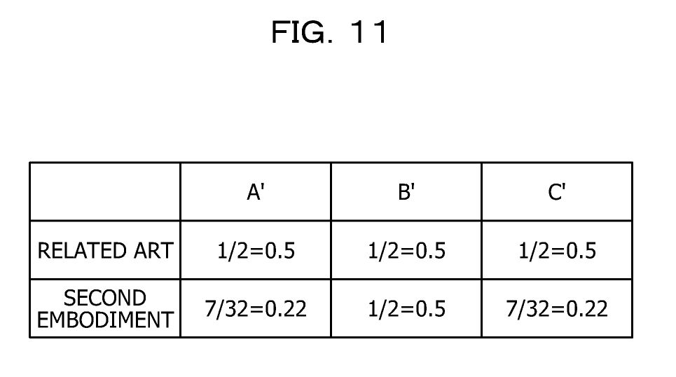

Accordingly, in a second embodiment given below, regarding a case in which a rearranging circuit is used at a previous stage to a 3-input adder, a configuration of an arithmetic circuit 10A according to the second embodiment and a process performed by the arithmetic circuit 10A will be described with reference to FIGS. 8 to 11. FIG. 8 is a block diagram of the configuration of the arithmetic circuit according to the second embodiment. FIG. 9 is a table for explaining the relationships between inputs and outputs of a rearranging circuit according to the second embodiment. FIG. 10 is a diagram for explaining a configuration of the rearranging circuit according to the second embodiment. FIG. 11 is a table for comparing signal change probabilities in the arithmetic circuit according to the second embodiment with signal change probabilities in an arithmetic circuit of the related art.

As illustrated in FIG. 8, the arithmetic circuit 10A according to the second embodiment includes rearranging a plurality of circuits 21 to 21 n and a 3-input adder 22. Each of outputs of the rearranging circuits 21 to 21n is connected to the 3-input adder 22 via three signal lines.

The rearranging circuit 21 of the arithmetic circuit 10A according to the second embodiment receives three input signals. When the rearranging circuit 21 determines that it is necessary to perform a rearrangement process for the combination of the three input signals, the rearranging circuit 21 performs the rearrangement process on the input signals.

For example, as illustrated in FIG. 9, when an input A is “0”, an input B is “1”, and an input C is “0”, the rearranging circuit 21 rearranges (or exchanges) the inputs A, B, and C to obtain an output A′ of “0”, an output B′ of “0”, and an output C′ of “1”. When the input A is “1”, the input B is “0”, and the input C is “0”, the rearranging circuit 21 rearranges the inputs A, B, and C to obtain the output A′ of “0”, the output B′ of “0”, and the output C′ of “1”.

Furthermore, when the input A is “1”, the input B is “0”, and the input C is “1”, the rearranging circuit 21 rearranges (or exchanges) the inputs A, B, and C to obtain the output A′ of “0”, the output B′ of “1”, and the output C′ of “1”. When the input A is “1”, the input B is “1”, and the input C is “0”, the rearranging circuit 21 rearranges the inputs A, B, and C to obtain the output A′ of “0”, the output B′ of “1”, and the output C′ of “1”.

Here, a circuit configuration of the rearranging circuit 21 will be described with reference to FIG. 10.

As illustrated in FIG. 10, the rearranging circuit 21 includes a plurality of NAND circuits, a plurality of NOR circuits, and a plurality of inverters. For example, when the input A is “0”, the input B is “1”, and the input C is “0”, the input A of “0” is input to one of the inverters, and the inverter outputs “1”. One of the NOR circuits is provided at a subsequent stage to the inverter. The NOR circuit outputs “0” as the output A′.

Furthermore, in the rearranging circuit 21, when the input A is “0”, the input B is “1”, and the input C is “0”, the input B of “1” and the input C of “0” are input to one of the NAND circuits, and the NAND circuit outputs “1”, whereby one of two inputs of another one of the NAND circuits, the NAND circuit being provided at a subsequent stage to the NAND circuit to which the input B of “1” and the input C of “0” have been input and being connected to the output B′, is “1”. The input A of “0” is input to the inverter, and the inverter outputs “1”. “1” that has been output from the inverter passes through another one of the NOR circuits and the other inverter, whereby the other input of the NAND circuit connected to the output B′ is “1”. Accordingly, because both of the inputs of the NAND circuit connected to the output B′ are “1”, “0” is output as the output B′. Furthermore, in rearranging circuit 21, when the input A is “0”, the input B is “1”, and the input C is “0”, the input B of “1” and the input C of “0” are input to the other NOR circuit, and the NOR circuit outputs “0”. The other NAND circuit is provided at a subsequent stage to the NOR circuit to which the input B of “1” and the input C of “0” have been input, and the NAND circuit outputs “1” as the output C′.

In other words, the rearranging circuit 21 performs a rearrangement process so that a probability that the output A′ is “0” is as high as possible and a probability that the output C′ is “1” is as high as possible. In this manner, by biasing the values of the outputs ‘A and C’ so that the values are specific values, the signal change probabilities, which are probabilities that the input signals in the next cycle do not change from the input signals in the current cycle, are reducible.

In this case, the rearranging circuit 21 performs the rearrangement process, whereby a probability of occurrence of the output A′ of “0” and a probability of occurrence of the output A′ of “1” are ⅞ and ⅛, respectively. Accordingly, a probability that the output A′ changes from “0” to “1” is 7/64, and a probability that the output A′ changes from “1” to “0” is also 7/64. As a result, as illustrated in FIG. 11, the rearranging circuit 21 performs the rearrangement process, whereby signal change probabilities are “ 7/32”. Thus, the signal change probabilities are reducible, compared with signal change probabilities of “½” in an arithmetic circuit of the related art in which no rearrangement process is performed.

As described above, in the arithmetic circuit 10A according to the second embodiment, when input signals are input from three paths, the individual input signals are rearranged (or exchanged) so that the values of the input signals which are input from the individual paths are biased. Thus, the signal change probabilities are reducible. As a result, the power consumption of the adder is reducible when the adder circuit operates.

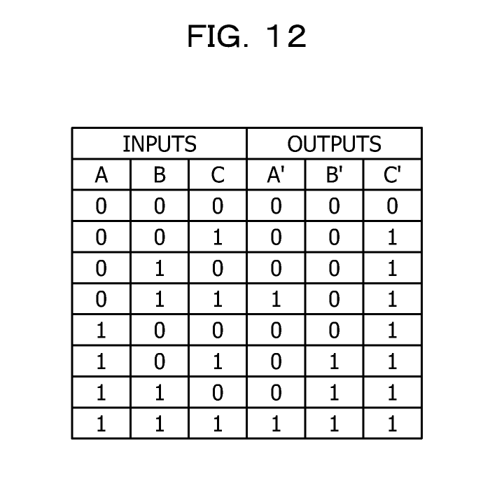

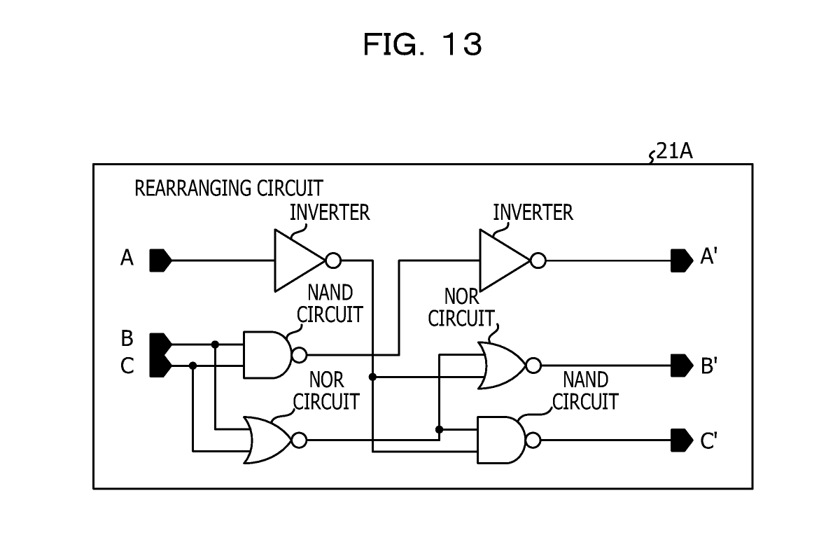

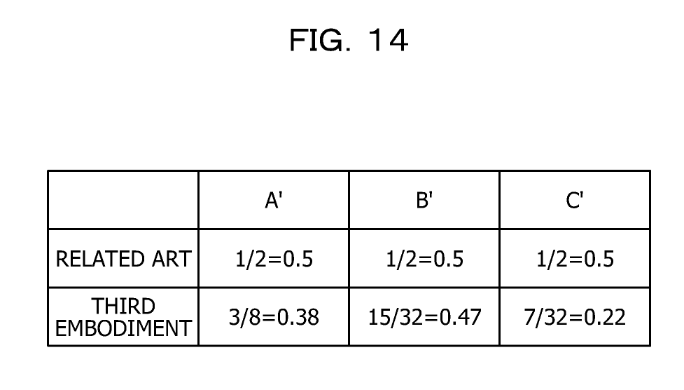

In the above-described second embodiment, a case in which a rearranging circuit is used at a previous stage to a 3-input adder is described. However, the rearranging circuit according to the second embodiment may be more simplified. Accordingly, in a third embodiment given below, regarding a case in which a rearranging circuit having a circuit configuration that is more simplified than the circuit configuration of the above-described rearranging circuit is used, a configuration of an arithmetic circuit 21A according to the third embodiment and a process performed by the arithmetic circuit 21A will be described with reference to FIGS. 12 to 14. FIG. 12 is a table for explaining the relationships between inputs and outputs of a rearranging circuit according to the third embodiment. FIG. 13 is a diagram for explaining a configuration of the rearranging circuit according to the third embodiment. FIG. 14 is a table for comparing signal change probabilities in the arithmetic circuit according to the third embodiment with signal change probabilities in an arithmetic circuit of the related art.

The rearranging circuit 21A according to the third embodiment receives three input signals as in the second embodiment. When the rearranging circuit 21A determines that it is necessary to perform a rearrangement process for the combination of the three input signals, the rearranging circuit 21A performs the rearrangement process on the input signals.

Here, as illustrated in FIG. 12, differently from the second embodiment, when an input A is “0”, an input B is “1”, and an input C is “1”, the rearranging circuit 21A according to the third embodiment rearranges (or exchanges) the inputs A, B, and C to obtain an output A′ of “1”, an output B′ of “0”, and an output C′ of “1”. Accordingly, the rearranging circuit is able to be more simplified.

Here, a circuit configuration of the rearranging circuit 21A will be described with reference to FIG. 13. As illustrated in FIG. 13, the rearranging circuit 21A is able to have a circuit configuration in which each of the number of NAND circuits and the number of NOR circuits is reduced by one, compared with a corresponding one of the number of NAND circuits and the number of NOR circuits in the circuit configuration of the rearranging circuit 21 according to the second embodiment.

Furthermore, the rearranging circuit 21A performs the rearrangement process, whereby a probability of occurrence of the output A′ of “0” and a probability of occurrence of the output A′ of “1” are 6/8 and 2/8, respectively. Accordingly, a probability that the output A′ changes from “0” to “1” is 12/64, and a probability that the output A′ changes from “1” to “0” is also 12/64. As a result, as illustrated in FIG. 14, the rearranging circuit 21 performs the process of rearranging the input signals, whereby signal change probabilities are “⅜”. Thus, the signal change probabilities is reducible, compared with signal change probabilities of “½” in an arithmetic circuit of the related art in which no process of rearranging input signals is performed.

As described above, in the arithmetic circuit according to the third embodiment, individual input signals that are input from individual paths are rearranged (or exchanged) using the rearranging circuit 21A having a simplified circuit configuration so that the values of the input signals are biased. Accordingly, the signal change probabilities are reducible while reducing the circuit scale. Thus, the power consumption of the adder is reducible when the adder circuit operates.

In the above-described second embodiment, a case in which a rearranging circuit is used at a previous stage to a 3-input adder is described. However, a rearranging circuit may be used at a previous stage to a 4-input adder.

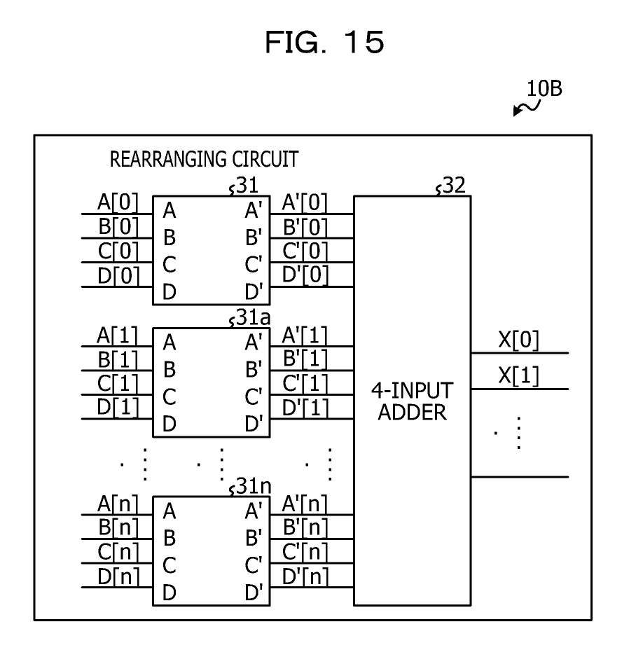

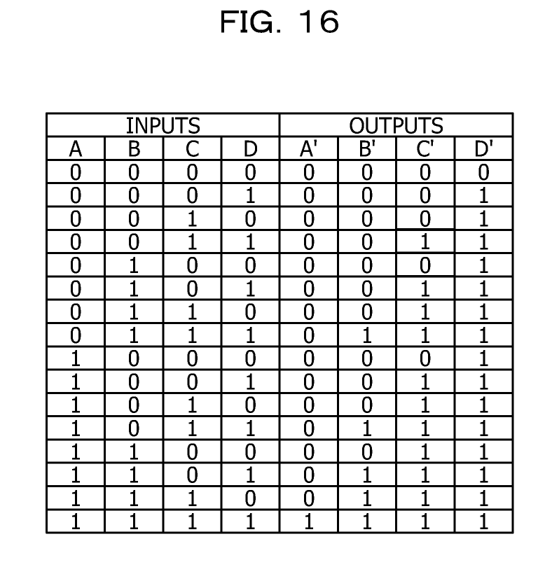

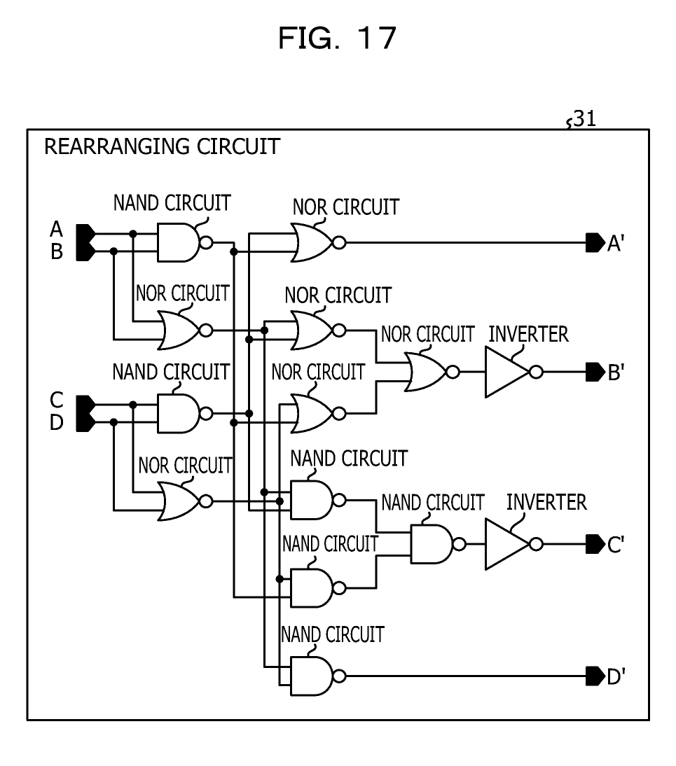

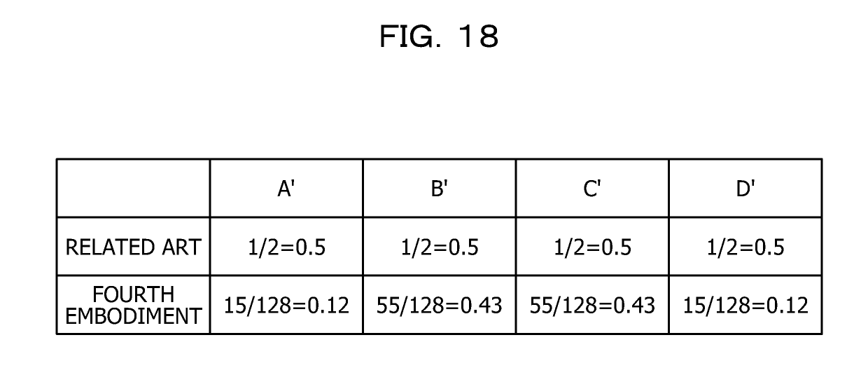

Accordingly, in a fourth embodiment given below, regarding a case in which a rearranging circuit is used at a previous stage to a 4-input adder, a configuration of an arithmetic circuit 10B according to the fourth embodiment and a process performed by the arithmetic circuit 10B will be described with reference to FIGS. 15 to 18. FIG. 15 is a block diagram of the configuration of the arithmetic circuit according to the fourth embodiment. FIG. 16 is a table for explaining the relationships between inputs and outputs of a rearranging circuit according to the fourth embodiment. FIG. 17 is a diagram for explaining a configuration of the rearranging circuit according to the fourth embodiment. FIG. 18 is a table for comparing signal change probabilities in the arithmetic circuit according to the fourth embodiment with signal change probabilities in an arithmetic circuit of the related art.

As illustrated in FIG. 15, the arithmetic circuit 10B according to the fourth embodiment includes rearranging a plurality of circuits 31 to 31n and a 4-input adder 32. Each of outputs of the rearranging circuits 31 to 31n is connected to the 4-input adder 32 via four signal lines.

The rearranging circuit 31 of the arithmetic circuit 10B according to the fourth embodiment receives four input signals. When the rearranging circuit 31 determines that it is necessary to perform a rearrangement process for the combination of the four input signals, the rearranging circuit 31 performs the rearrangement process on the input signals.

For example, as illustrated in FIG. 16, when an input A is “0”, an input B is “0”, an input C is “1”, and an input D is “0”, the rearranging circuit 31 rearranges (or exchanges) the inputs A, B, C, and D to obtain an output A′ of “0”, an output B′ of “0”, an output C′ of “0”, and an output D′ of “1”. When the input A is “0”, the input B is “1”, the input C is “0”, and the input D is “0”, the rearranging circuit 31 rearranges (or exchanges) the inputs A, B, C, and D to obtain the output A′ of “0”, the output B′ of “0”, the output C′ of “0”, and the output D′ of “1”.

Furthermore, when the input A is “0”, the input B is “1”, the input C is “0”, and the input D is “1”, the rearranging circuit 31 rearranges (or exchanges) the inputs A, B, C, and D to obtain the output A′ of “0”, the output B′ of “0”, the output C′ of “1”, and the output D′ of “1”. When the input A is “0”, the input B is “1”, the input C is “1”, and the input D is “0”, the rearranging circuit 31 rearranges the inputs A, B, C, and D to obtain the output A′ of “0”, the output B′ of “0”, the output C′ of “1”, and the output D′ of “1”.

Moreover, when the input A is “1”, the input B is “0”, the input C is “0”, and the input D is “0”, the rearranging circuit 31 rearranges (or exchanges) the inputs A, B, C, and D to obtain the output A′ of “0”, the output B′ of “0”, the output C′ of “0”, and the output D′ of “1”. When the input A is “1”, the input B is “0”, the input C is “0”, and the input D is “1”, the rearranging circuit 31 rearranges the inputs A, B, C, and D to obtain the output A′ of “0”, the output B′ of “0”, the output C′ of “1”, and the output D′ of “1”.

Additionally, when the input A is “1”, the input B is “0”, the input C is “1”, and the input D is “0”, the rearranging circuit 31 rearranges (or exchanged) the inputs A, B, C, and D to obtain the output A′ of “0”, the output B′ of “0”, the output C′ of “1”, and the output D′ of “1”. When the input A is “1”, the input B is “0”, the input C is “1”, and the input D is “1”, the rearranging circuit 31 rearranges the inputs A, B, C, and D to obtain the output A′ of “0”, the output B′ of “1”, the output C′ of “1”, and the output D′ of “1”.

Furthermore, when the input A is “1”, the input B is “1”, the input C is “0”, and the input D is “0”, the rearranging circuit 31 rearranges (or exchanges) the inputs A, B, C, and D to obtain the output A′ of “0”, the output B′ of “0”, the output C′ of “1”, and the output D′ of “1”. When the input A is “1”, the input B is “1”, the input C is “0”, and the input D is “1”, the rearranging circuit 31 rearranges the inputs A, B, C, and D to obtain the output A′ of “0”, the output B′ of “1”, the output C′ of “1”, and the output D′ of “1”.

Moreover, when the input A is “1”, the input B is “1”, the input C is “1”, and the input D is “0”, the rearranging circuit 31 rearranges the inputs A, B, C, and D to obtain the output A′ of “0”, the output B′ of “1”, the output C′ of “1”, and the output D′ of “1”.

Here, a circuit configuration of the rearranging circuit 31 will be described with reference to FIG. 17. As illustrated in FIG. 17, the rearranging circuit 31 includes a plurality of NAND circuits, a plurality of NOR circuits, and a plurality of inverters. For example, when the input A is “0”, the input B is “1”, the input C is “1”, and the input D is “0”, “0”, “0”, “1”, and “1” are output as the outputs A′, B′, C′, and D′, respectively, via the NAND circuits, the NOR circuits, and the inverters.

In other words, the rearranging circuit 31 performs the rearrangement process so that the degree to which it is preferable that the outputs are “0” decreases in the order of the outputs A′, B′, C′, and D′. Furthermore, the rearranging circuit 31 performs the rearrangement process so that the degree to which it is preferable that the outputs are “1” decreases in the order of the outputs D′, C′, B′, and A′. In this manner, by biasing the values of the outputs A′, B′, C′, and D′ so that the values are specific values, the signal change probabilities, which are probabilities that the input signals in the next cycle change from the input signals in the current cycle, are reducible.

In this case, the rearranging circuit 31 performs the rearrangement process, whereby a probability of occurrence of the output A′ of “0” and a probability of occurrence of the output A′ of “1” are 15/16 and 1/16, respectively. Accordingly, a probability that the output A′ changes from “0” to “1” is 15/256, and a probability that the output A′ changes from “1” to “0” is also 15/256. As a result, as illustrated in FIG. 18, the rearranging circuit 31 performs the rearrangement process, whereby signal change probabilities are “15/128”. Thus, the signal change probabilities are reducible, compared with signal change probabilities of “½” in an arithmetic circuit of the related art in which no rearrangement process is performed.

As described above, in the arithmetic circuit 10B according to the fourth embodiment, when input signals are input from four paths, the individual input signals are rearranged so that the values of the input signals which are input from the individual paths are biased. Thus, the signal change probabilities are reducible. As a result, the power consumption of the adder is reducible when the adder circuit operates.

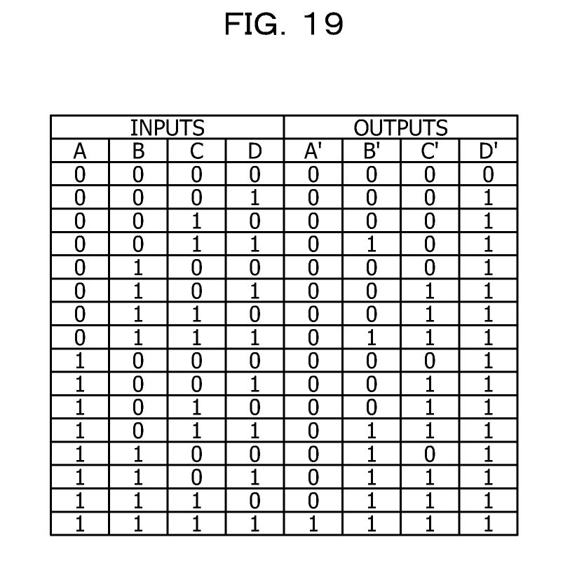

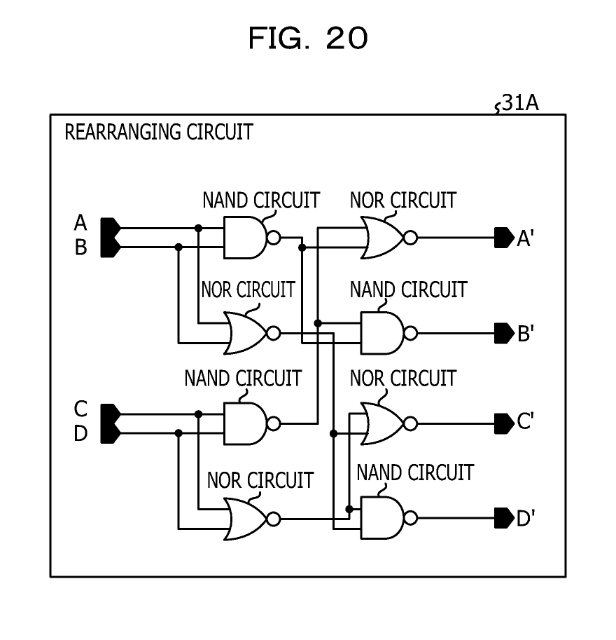

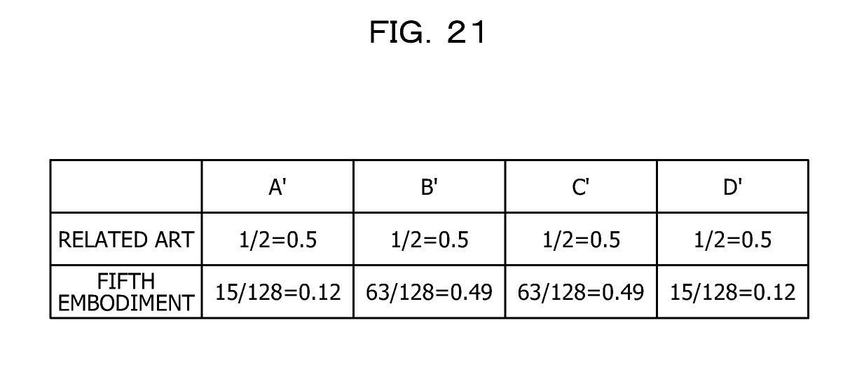

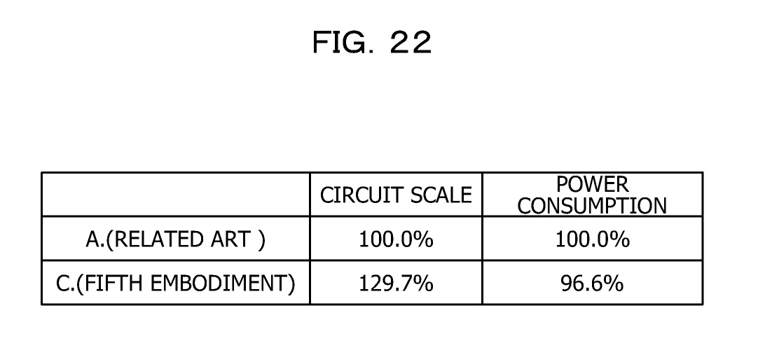

In the above-described fourth embodiment, a case in which a rearranging circuit is used at a previous stage to a 4-input adder is described. However, the rearranging circuit according to the fourth embodiment may be more simplified. Accordingly, in a fifth embodiment given below, regarding a case in which a rearranging circuit having a circuit configuration that is more simplified than the circuit configuration of the above-described rearranging circuit is used, a configuration of an arithmetic circuit 31A according to the fifth embodiment and a process performed by the arithmetic circuit 31A will be described with reference to FIGS. 19 to 22. FIG. 19 is a table for explaining the relationships between inputs and outputs of a rearranging circuit according to the fifth embodiment. FIG. 20 is a diagram for explaining a configuration of the rearranging circuit according to the fifth embodiment. FIG. 21 is a table for comparing signal change probabilities in the arithmetic circuit according to the fifth embodiment with signal change probabilities in an arithmetic circuit of the related art. FIG. 22 is a table for comparing the arithmetic circuit according to the fifth embodiment and the arithmetic circuit of the related art in terms of circuit scale and power consumption.

The rearranging circuit 31A according to the fifth embodiment receives four input signals as in the fourth embodiment. When the rearranging circuit 31A determines that it is necessary to perform a rearrangement process for the combination of the four input signals, the rearranging circuit 31 A performs the rearrangement process on the input signals.

Here, as illustrated in FIG. 19, differently from the fourth embodiment, when an input A is “0”, an input B is “0”, an input C is “1”, and an input D is “1”, the rearranging circuit 31A according to the fifth embodiment rearranges (or exchanges) the inputs A, B, C, and D to obtain an output A′ of “0”, an output B′ of “1”, an output C′ of “0” and an output D′ of “1”. Furthermore, when the input A is “1”, the input B is “1”, the input C is “0”, and the input D is “0”, the rearranging circuit 31A rearranges the inputs A, B, C, and D to obtain the output A′ of “0”, the output B′ of “1”, the output C′ of “0” and the output D′ of “1”. Accordingly, the rearranging circuit is able to be more simplified.

Here, a circuit configuration of the rearranging circuit 31A will be described with reference to FIG. 20. As illustrated in FIG. 20, the rearranging circuit 31A is able to have a circuit configuration in which each of the number of NAND circuits, the number of NOR circuits, and the number of inverters is reduced by two, compared with a corresponding one of the number of NAND circuits, the number of NOR circuits, and the number of inverters in the circuit configuration of the rearranging circuit 31 according to the fourth embodiment.

Furthermore, as illustrated in FIG. 21, the rearranging circuit 31 performs the rearrangement process on the input signals, whereby signal change probabilities for the outputs A′ and D′ are “15/128” as in the fourth embodiment. Thus, the signal change probabilities are reducible, compared with signal change probabilities of “½” in an arithmetic circuit of the related art in which no rearrangement process is performed. Note that signal change probabilities for the outputs B′ and C′ are increased, compared with those in the fourth embodiment.

As described above, in the arithmetic circuit according to the fifth embodiment, individual input signals that are input from individual paths are rearranged using the rearranging circuit 31A having a simplified circuit configuration so that the values of the input signals are biased. Accordingly, the signal change probabilities are reducible while reducing the circuit scale. Thus, the power consumption of the adder is reducible when the adder circuit operates.

Here, the arithmetic circuit according to the fifth embodiment is compared with the arithmetic circuit of the related art in terms of circuit scale and power consumption with reference to FIG. 22. As illustrated in FIG. 22, the circuit scale of the arithmetic circuit according to the fifth embodiment is larger than that of the arithmetic circuit of the related art in which no rearranging circuit is used. However, the power consumption of the arithmetic circuit according to the fifth embodiment is reducible.

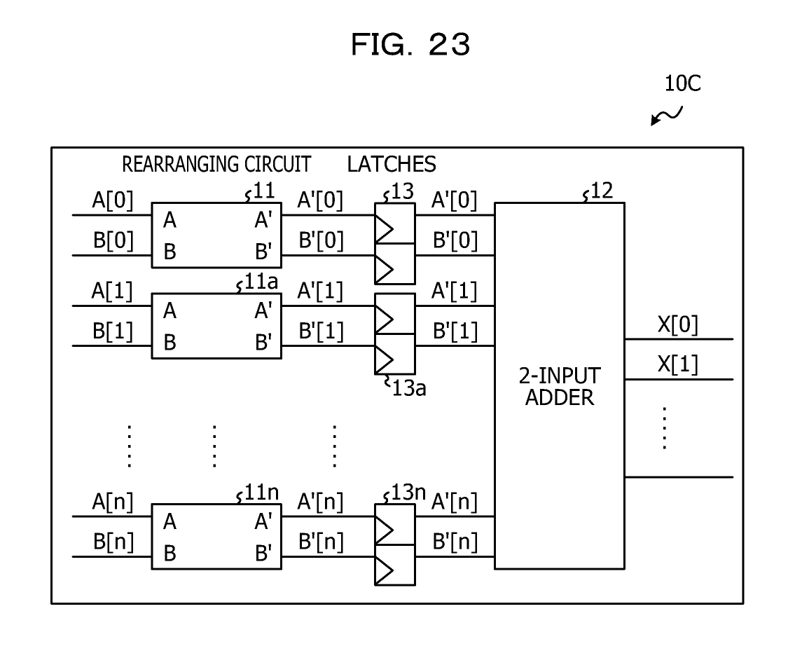

Latches may be used at a subsequent stage to rearranging circuits and at a previous stage to an input adder. Accordingly, in a sixth embodiment given below, regarding a case in which latches are used at a subsequent stage to rearranging circuits and at a previous stage to an input adder, a configuration of an arithmetic circuit 100 according to the sixth embodiment and a process performed by the arithmetic circuit 10C will be described with reference to FIG. 23. FIG. 23 is a block diagram of the configuration of the arithmetic circuit according to the sixth embodiment.

As illustrated in FIG. 23, when the arithmetic circuit 100 is compared with the arithmetic circuit 10 according to the first embodiment, the difference therebetween is that the arithmetic circuit 100 further includes a plurality of latches 13 to 13n. In the arithmetic circuit 10C, the latches 13 to 13n make timings at which the input signals are input to the 2-input adder 12 the same.

Accordingly, even when timings at which the input signals that are input as two inputs change are different from each other, changes that are caused by shifts between the timings at which the input signals are input from the latches 13 to the 2-input adder 12 are reducible. Note that, even when the adder has three or more inputs, the latches are able to be applied in a manner similar to the above-described manner.

As described above, in the arithmetic circuit 100 according to the sixth embodiment, when input signals are to be individually input from a plurality of paths, the input signals are rearranged by the rearranging circuits. The input signals that have been rearranged are received by the individual paths. Timings at which the input signals are input from the individual paths to the adder are made to coincide with each other, and the input signals are output to the adder. Accordingly, changes that are caused by shifts between the timings at which the input signals are input to the adder are reducible.

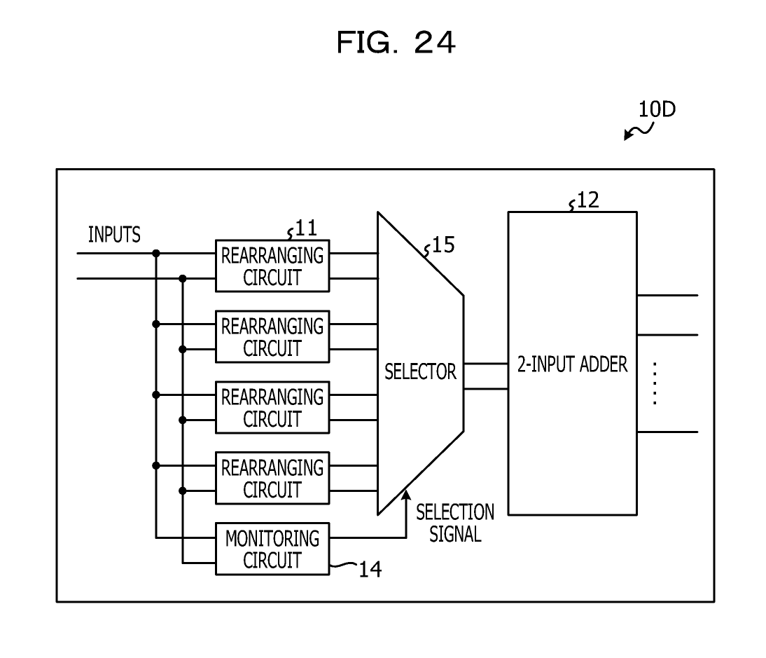

In the above-described first to sixth embodiments, a case in which one type of rearranging circuits is used is described. However, a plurality of types of rearranging circuits may be placed, and one of the rearranging circuits may be selected as a rearranging circuit to be used. Accordingly, in a seventh embodiment given below, regarding a case in which input signals are monitored and in which one of rearranging circuits is selected as a rearranging circuit to be used, a configuration of an arithmetic circuit 10D according to the seventh embodiment and a process performed by the arithmetic circuit 10D will be described with reference to FIG. 24. FIG. 24 is a block diagram of the configuration of the arithmetic circuit according to the seventh embodiment.

As illustrated in FIG. 24, when the arithmetic circuit 10D is compared with the arithmetic circuit 10 according to the first embodiment, the difference therebetween is that the arithmetic circuit 10D further includes a plurality of types of rearranging circuits 11, a monitoring circuit 14, and a selector 15. In the arithmetic circuit 10D, each of the rearranging circuits 11 uses a method for rearranging input signals, and the methods for rearranging input signals are different from one another. In the methods, the relationships between inputs and outputs for the input signals are different from one another.

The monitoring circuit 14 monitors input signals for the individual rearranging circuits 11. More specifically, the monitoring circuit 14 determines whether each of input signals that are to be input to the individual rearranging circuits 11 is “0” or “1”, and counts the number of “0”s and the number of “1”s, thereby obtaining a ratio of the occurrence of “0”s to the occurrence of “1”s. The monitoring circuit 14 monitors whether or not the ratio of the occurrence of “0”s to the occurrence of “1”s becomes unbalanced. Then, the monitoring circuit 14 selects one of the rearranging circuits 11 as a rearranging circuit that is to be used for the selector 15 in accordance with a result of monitoring. Supply of power for the rearranging circuits 11 that are not to be used and for the selector 15 is stopped.

In other words, when the values of the input signals are not randomized and the ratio of the occurrence of “0”s to the occurrence of “1”s becomes unbalanced, conversely, a probability that the input signals change may be increased depending on a method for rearranging the input signals. Accordingly, the power consumption of the arithmetic circuit may be increased. Thus, the power consumption is reducible by selecting the most appropriate rearranging circuit.

As described above, in the arithmetic circuit 10D according to the seventh embodiment, the plurality of rearranging circuits is included. Each of the rearranging circuits uses a method for rearranging input signals, and the methods for rearranging input signals are different from one another. The input signals that are to be input to the plurality of rearranging circuits are monitored. One of the plurality of rearranging circuits is selected in accordance with a result of monitoring the input signals. Accordingly, the most appropriate rearranging circuit is selected in accordance with probabilities of occurrence of values of the input signals. Thus, the power consumption is reducible when the adder circuit operates.

The first to seventh embodiments have been described above. However, in addition to the above-described embodiments, the present embodiment may be realized in various different forms. Accordingly, hereinafter, another embodiment included in the present embodiment will be described as an eighth embodiment.

In the above-described first to seventh embodiments described above, a case is described, in which an adder is applied as a circuit that is targeted for reduction in power consumption when the circuit operates. However, the present embodiment is not limited thereto. Any circuit through which current flows only when input signals change, and which obtains a result that does not change even when the input signals are rearranged as equivalent signals having the same weight is able to be applied. For example, also when a multiplier is applied instated of an adder, the present embodiment is able to be realized.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An arithmetic circuit, comprising:
a rearranging unit that rearranges input signals sequentially inputted to the rearranging unit, so that current input signals do not change from immediately previous input signals; and
an arithmetic processing unit that performs an arithmetic process on the input signals rearranged by the rearranging unit.

2. The arithmetic circuit according to claim 1, wherein when a plurality of input signals are inputted from a plurality of paths, the rearranging unit rearranges the plurality of the input signals so that values of the plurality of input signals are biased.

3. The arithmetic circuit according to claim 2, wherein the rearranging unit rearranges the plurality of signals and outputs the rearranged plurality of signals so that the rearranged plurality of signals are inputted to the arithmetic processing unit simultaneously, when the plurality of input signals are inputted to the rearranging unit from a plurality of paths.

4. The arithmetic circuit according to claim 2, further comprising:
a plurality of rearranging units that each rearranges the plurality of input signals in different way from one another;
a monitoring unit that monitors the plurality of input signals inputted to the plurality of rearranging units; and
a selection unit that selects one of the plurality of rearranging units in accordance with a monitoring result of the plurality of input signals by the monitoring unit.

5. A power saving method for an arithmetic circuit including a rearranging unit and an arithmetic processing unit, the power saving method comprising:
rearranging input signals sequentially inputted to the rearranging unit, so that current input signals do not change from immediately previous input signals; and
performing an arithmetic process on the input signals rearranged by the rearranging.
